(19) United States
(12) Patent Application Publication
(10) Pub. No.: US 2014/0299354 A1
(43) Pub. Date: Oct. 9, 2014

(54) CUSTOM CABLE TECHNOLOGY

(71) Applicant: Howard Lind, Porter Rance, CA (US)

(72) Inventor: Howard Lind, Porter Rance, CA (US)

(21) Appl. No.: 14/214,104

(22) Filed: Mar. 14, 2014

Related U.S. Application Data
(60) Provisional application No. 61/785,685, filed on Mar. 14, 2013.

(51) Int. Cl. H01B 7/08; H01B 13/00

(52) U.S. Cl. CPC H01B 7/08; H01B 13/00
USPC 174/117 F; 29/825; 29/745

(57) ABSTRACT

The embodiments disclose a method including fabricating custom cables using a custom cable technology, wherein the custom cables include a universal flat cable including a plurality of flexible conduits including a plurality of cable pods, an ultra-flat cable and a flat series cable, and wherein the custom cables include reinforced cable jackets, and wherein the custom cables include reduced weight cable jackets including a microcell jacket.

### CROSS-REFERENCE TO RELATED APPLICATIONS

This application is based on U.S. Provisional Patent Application Ser. No. 61/785,685 filed Mar. 14, 2013, entitled “Custom Cable Techology”, by First Named Inventor Howard Lind, et al..

### BRIEF DESCRIPTION OF THE DRAWINGS

FIG. 1 shows a block diagram of an overview of a custom cable technology of one embodiment.

FIG. 2A shows a block diagram of an overview of a versaflex flat cable of one embodiment.

FIG. 2B shows for illustrative purposes only an example of a versaflex universal flat cable with multiple flexible conduits of one embodiment.

FIG. 2C shows for illustrative purposes only an example of a versaflex flat cable with a pod split away and branched off of one embodiment.

FIG. 3A shows a block diagram of an overview of a psi-guard tubing of one embodiment.

FIG. 3B shows for illustrative purposes only an example of a clear mesh encases the tubing of one embodiment.

FIG. 4 shows a block diagram of an overview of a toughline flat cable of one embodiment.

FIG. 5A shows a block diagram of an overview of a microcell jacket and an ultralite cable of one embodiment.

FIG. 5B shows for illustrative purposes only an example of a microcell jacket manufacturing process of one embodiment.

FIG. 6A shows a block diagram of an overview of an ultra-flat cables of one embodiment.

FIG. 6B shows for illustrative purposes only an example of an ultra-flat thin flat magnet type wire of one embodiment.

FIG. 7A shows a block diagram of an overview of a flat series cable for USB applications of one embodiment.

FIG. 7B shows for illustrative purposes only an example of a flat series USB cable of one embodiment.

FIG. 8A shows a block diagram of an overview of a flat series cable for CAT6 applications of one embodiment.

FIG. 8B shows for illustrative purposes only an example of a flat series CAT6 cable of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope.

### General Overview:

It should be noted that the descriptions that follow, for example, in terms of custom cable technology is described for illustrative purposes and the underlying system can apply to any number and multiple types of cable. In one embodiment, the custom cable technology can be configured using a universal flat cable with multiple flexible conduits. The custom cable technology can be configured to include mesh encased jacketing and can be configured to include bubble infused jacketing using the present invention.

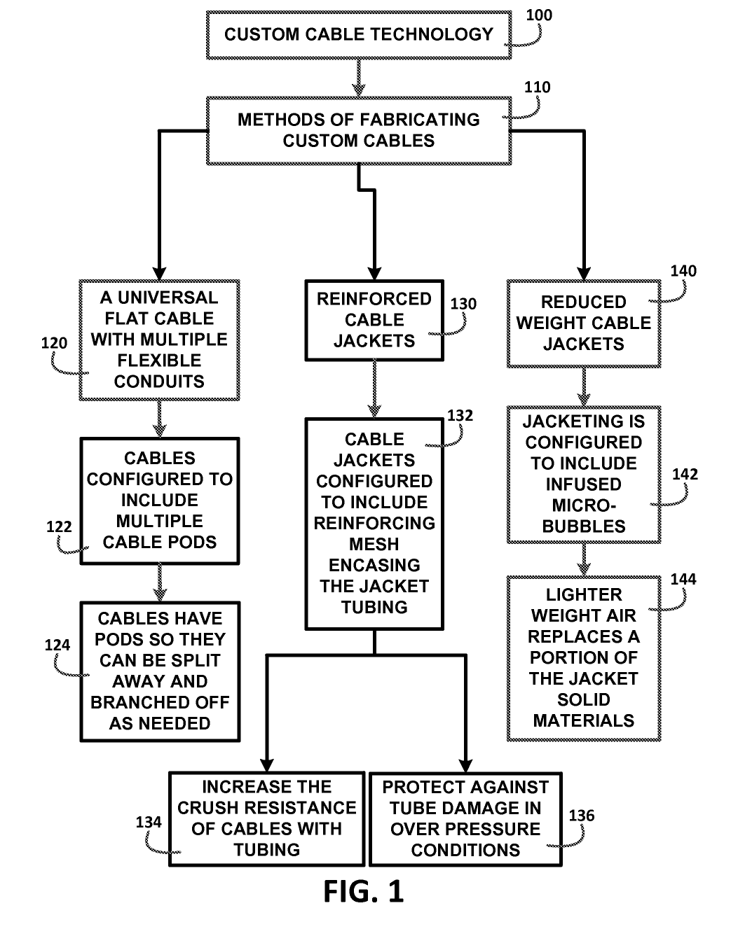

FIG. 1 shows a block diagram of an overview of a custom cable technology of one embodiment. FIG. 1 shows custom cable technology 100 that includes methods of fabricating custom cables 110. The custom cable technology 100 includes in one embodiment a universal flat cable with multiple flexible conduits 120 including cables configured to include multiple cable pods 122. Cables have pods so they can be split away and branched off as needed 124. The custom cable technology 100 includes in one embodiment reinforced cable jackets 130. The outer covering of a cable is the jacket. The reinforced cable jackets 130 include cable jackets configured to include reinforcing mesh encasing the jacket tubing 132. The reinforced cable jackets 130 create features to increase the crush resistance of cables with tubing 134 and to protect against tube damage in over pressure conditions 136.

The custom cable technology 100 includes in one embodiment reduced weight cable jackets 140. The total weight of a cable affects cartage, handling and in some cases installations. The reduced weight cable jackets 140 include jacketing that is configured to include infused micro-bubbles 142. Infusing micro-bubbles reduces cable weight where lighter weight air replaces a portion of the jacket solid materials 144 of one embodiment.

### DETAILED DESCRIPTION

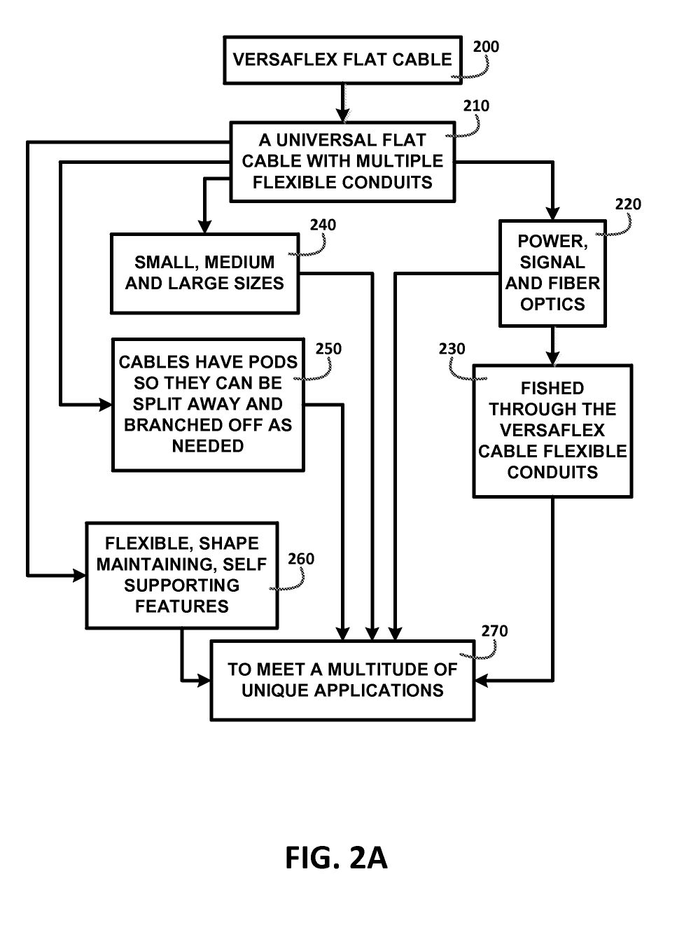

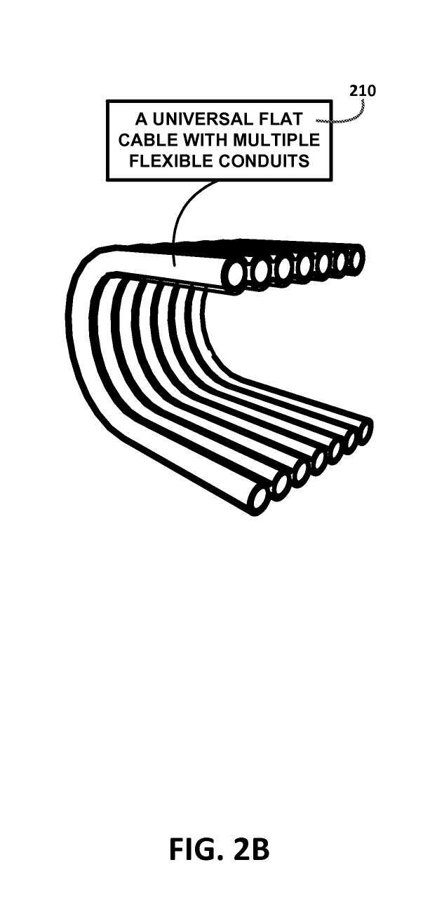

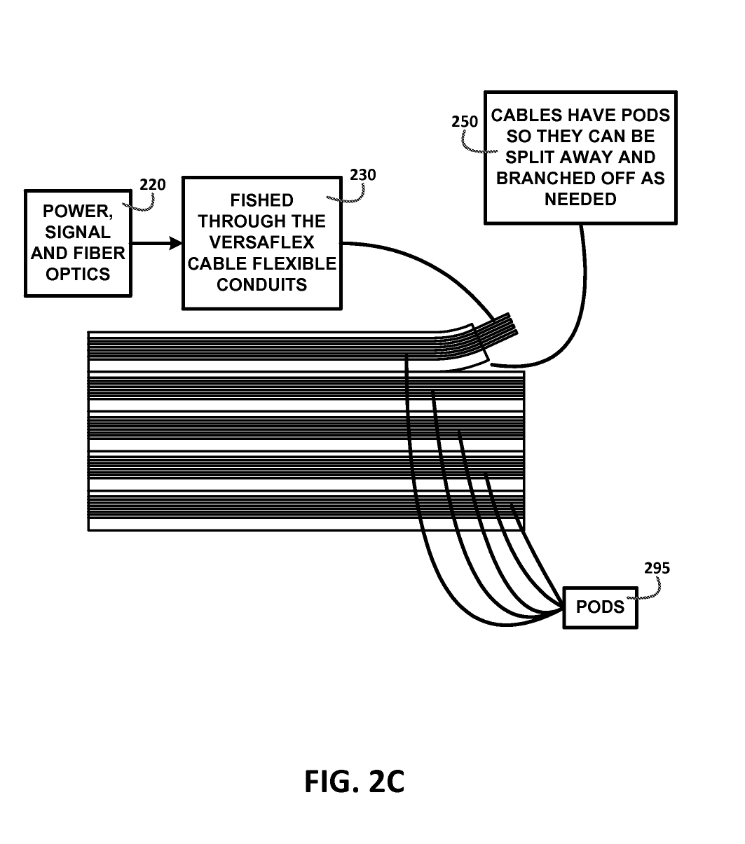

FIG. 2A shows a block diagram of an overview of a versaflex flat cable of one embodiment. FIG. 2A shows a universal flat cable with multiple flexible conduits 120 including a versaflex flat cable 200 that is configured for uses including power, signal and fiber optics 220. The versaflex flat cable 200 includes for example conductors, communication conductors, fiber optic cable and other types of cable and wiring that are fished through the versaflex cable flexible conduits 230. The versaflex flat cable 200 is configured in small, medium and large sizes 240 to customize installations of various cabling applications.

In one embodiment the versaflex flat cable 200 is configured where cables have pods so they can be split away and branched off as needed 124. The pod feature is used for example where a power and communication source location is run to multiple outlets where power or communication or both are to provide service. The pods in the versaflex flat cable 200 can be configured to split-off power only pods to some outlets, communication only pods to other outlets and combination pods to yet another class of outlets.

In one embodiment the versaflex flat cable 200 is configured to include flexible, shape maintaining, self-supporting features 260. The versaflex flat cable 200 features described in the embodiments allow the versaflex flat cable 200 to meet a multitude of unique applications 270 of one embodiment.

### Versaflex Universal Flat Cable:

FIG. 2B shows for illustrative purposes only an example of a versaflex universal flat cable with multiple flexible conduits of one embodiment. FIG. 2B shows a universal flat cable with multiple flexible conduits 210. The multiple flexible conduits are used for example for conveying conductors, communication conductors, fiber optic cable and other types of cable and wiring that can be fished through the conduits of one embodiment.

Versaflex Flat Cable with a Pod Split Away and Branched Off:

FIG. 2C shows for illustrative purposes only an example of a versaflex flat cable with a pod split away and branched off of one embodiment. FIG. 2C shows power, signal and fiber optics 220 fished through the versaflex cable flexible conduits 230. The versaflex flat cable includes features where cables have pods so they can be split away and branched off as needed 250. Shown in the illustrations is one of the pods 295 being split away to branch the cable run in another direction of one embodiment.

### Psi-Guard Tubing:

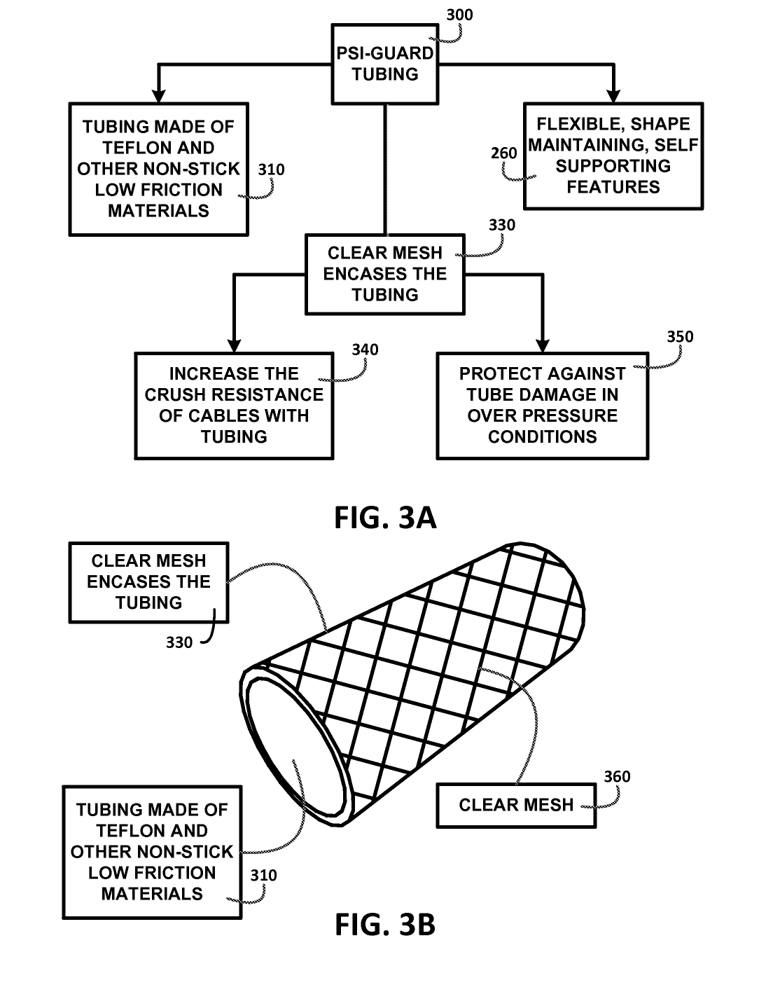

FIG. 3A shows a block diagram of an overview of a PSI-Guard Tubing of one embodiment. FIG. 3A shows psi-guard tubing 300 including tubing made of Teflon and other non-stick low friction materials 310. In one embodiment the psi-guard tubing 300 is configured to include flexible, shape maintaining, self-supporting features 260. In another embodiment the psi-guard tubing 300 is configured where clear mesh encases the tubing 330 to increase the crush resistance of cables with tubing 340 and protect against tube damage in over pressure conditions 350. The clear mesh provides reinforcement to the tubing jacket that protects the tubing and cabling fished through the interior of the tubing by adding crush resistance from the outside and damage in over pressure conditions from the inside. Over pressure from the inside of the tubing can be from for example a pressurized fluid being conveyed through the tubing of one embodiment.

### Clear Mesh Encases the Tubing:

FIG. 3B shows for illustrative purposes only an example of a clear mesh encases the tubing of one embodiment. FIG. 3B shows clear mesh encases the tubing 330 including tubing made of Teflon and other non-stick low friction materials 310. Clear mesh 360 can be embedded into the jacket material or integrated at a pre-determined depth into the jacket material at the time the jacket is applied of one embodiment.

### Toughline Flat Cables:

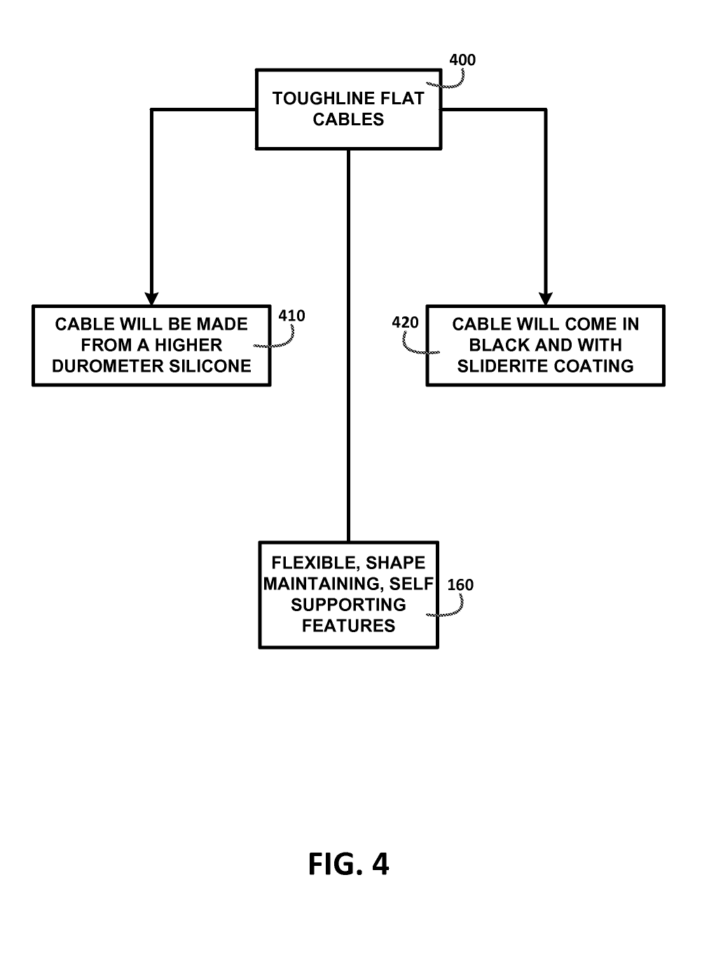

FIG. 4 shows a block diagram of an overview of a toughline flat cable of one embodiment. FIG. 4 shows toughline flat cables 400 wherein cable will be made from a higher durometer silicone 410. A Durometer is the International Standard Instrument used to measure the hardness of rubber or rubber-like materials for example silicone. Durometers measure hardness by the penetration of an indentor into the rubber sample. The calibrated reading is expressed in a number value. The higher the number values the harder the material. The toughline flat cables 400 include where a cable will come in black and with sliderite coating 420. The toughline flat cables 400 include flexible, shape maintaining, self-supporting features 260 of one embodiment.

### Microcell Jacket and Ultralite Cable:

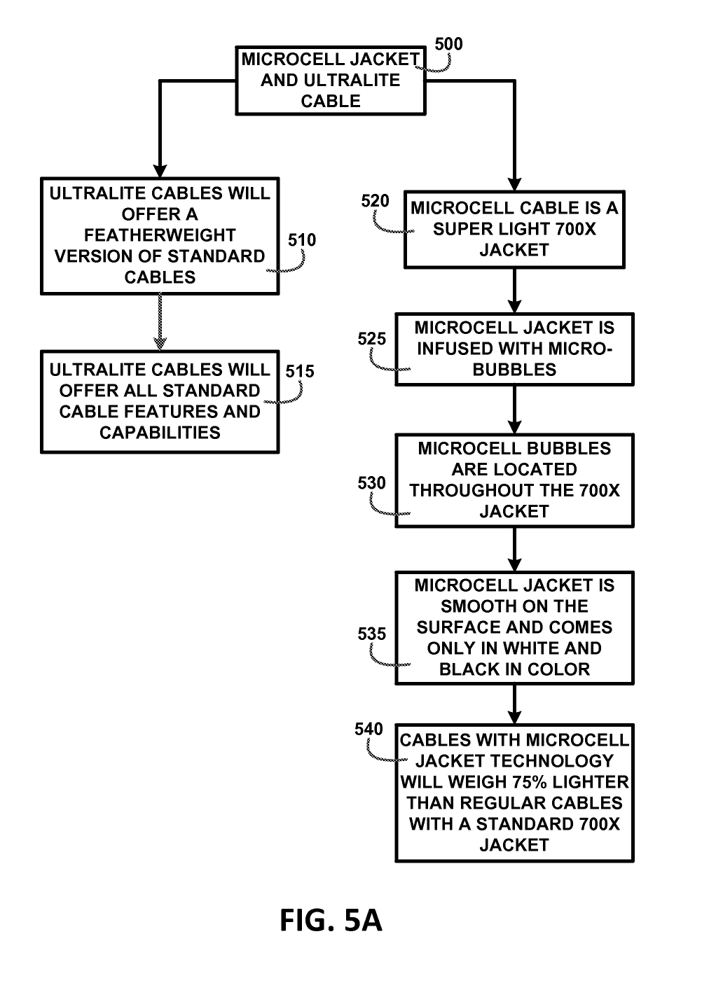

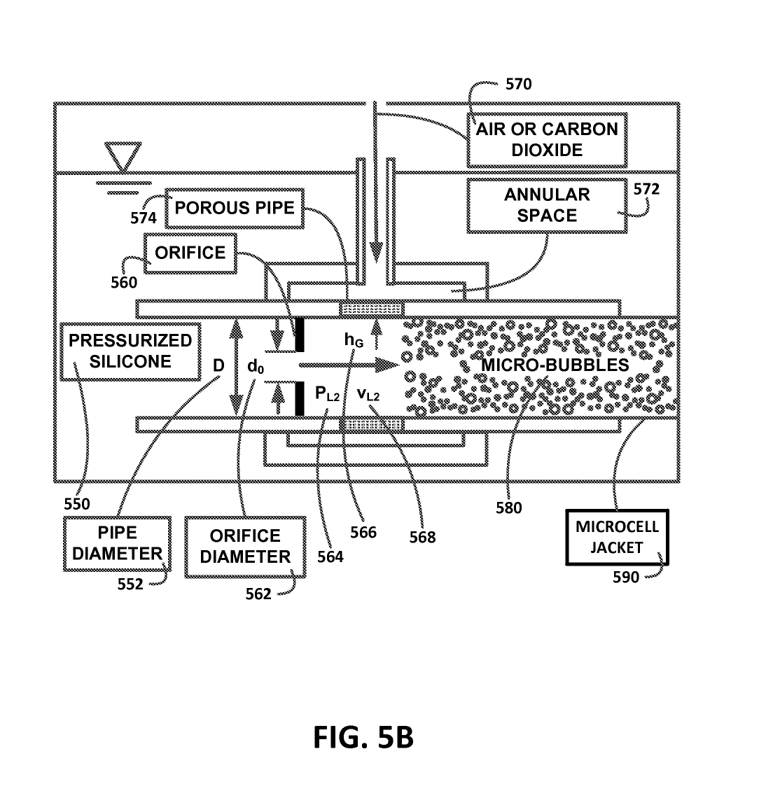

FIG. 5A shows a block diagram of an overview of a microcell jacket and ultralite cable of one embodiment. FIG. 5A shows a microcell jacket and ultralite cable 500. Ultralite cables offer a featherweight version of standard cables 510. Ultralite cables offer all standard cable features and capabilities 515. A microcell cable includes a super light 700x jacket 520. The super light 700x jacket is a microcell jacket where the microcell jacket is infused with micro-bubbles 525. Microcell bubbles are located throughout the 700x jacket 530. The microcell jacket is smooth on the surface and comes only in white and black in color 535. The total weight of a cable affects cartage, handling and in some cases installations. The reduced weight cable jackets 140 of FIG. 1 include jacketing that is configured to include infused micro-bubbles 142 of FIG. 1. Infusing micro-bubbles reduces cable weight where lighter weight air replaces a portion of the jacket solid materials 144 of FIG. 1. Cables with microcell jacket technology will weigh 75% lighter than regular cables with a standard 700x jacket 540 of one embodiment.

### Microcell Jacket Manufacturing Process:

FIG. 5B shows for illustrative purposes only an example of a microcell jacket manufacturing process of one embodiment. FIG. 5B shows a microcell jacket manufacturing process where pressurized silicone 550 is conveyed through a pipe with a pipe diameter 552 “D”. The flow of pressurized silicone 550 being conveyed through the pipe passes through an orifice 560 with an orifice diameter 562, where the orifice diameter 562 “d₀” is less than the pipe diameter 552 “D”. Air or carbon dioxide 570 is passed into an annular space 572 of a mixing structure 576 that includes a section of porous pipe 574. The Air or carbon dioxide 570 is infused into the pressurized silicone 550 and forming micro-bubbles 580 throughout the silicone. The pressure P_{L2} 564 in the volume v_{L2} 568 of the pressurized silicone 550 exerts a head pressure of the gas h_{G} 566 against the incoming air or carbon dioxide 570 causing the air or carbon dioxide 570 to diffuse and forming the micro-bubbles 580 where the micro-bubbles 580 become infused throughout the silicone. The pressurized silicone 550 with the micro-bubbles 580 infused throughout is formed into the desired shape using the discharge section of the mixing structure 576 to create a microcell jacket 590 to be integrated with the cabling and tubing to form the microcell jacket and ultralite cable 500 of FIG. 5A of one embodiment.

### Ultra-Flat Cables:

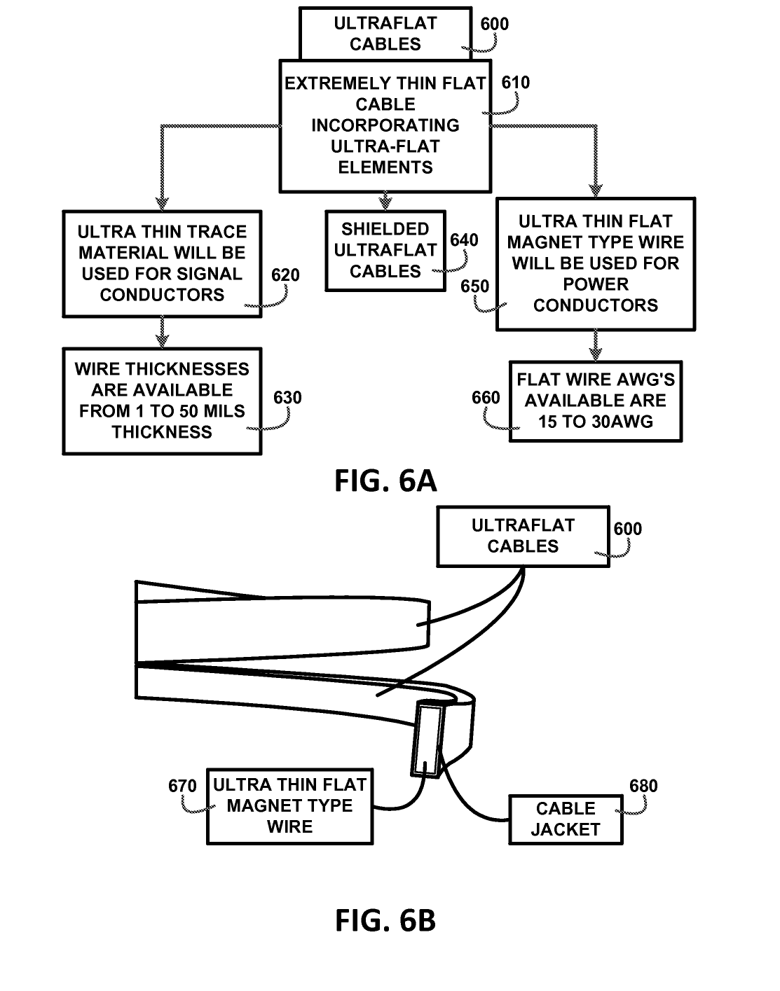

FIG. 6A shows a block diagram of an overview of an ultra-flat cables of one embodiment. FIG. 6A shows ultra-flat cables 600 including extremely thin flat cable incorporating ultra-flat elements 610 and shielded ultra-flat cables 640. In one embodiment ultra-thin trace material will be used for signal conductors 620. In another embodiment extremely thin flat cable incorporating ultra-flat elements 610 include wire thicknesses are available from 1 to 50 mils thickness 630. In one embodiment ultra-thin flat magnet type wire is used for power conductors 650 including flat wire AWG's available are 15 to 30 AWG 660 of one embodiment.

### Ultra-Flat Thin Flat Magnet Type Wire:

FIG. 6B shows for illustrative purposes only an example of an ultra-flat thin flat magnet type wire of one embodiment. FIG. 6B shows one embodiment of the ultra-flat cables 600. The embodiment shown includes an ultra-thin flat magnet type wire 670 and a cable jacket 680. The ultra-flat cables 600 in another embodiment includes the ultra-thin trace material will be used for signal conductors 620 of FIG. 6A.

### Flat Series Cable for USB Applications:

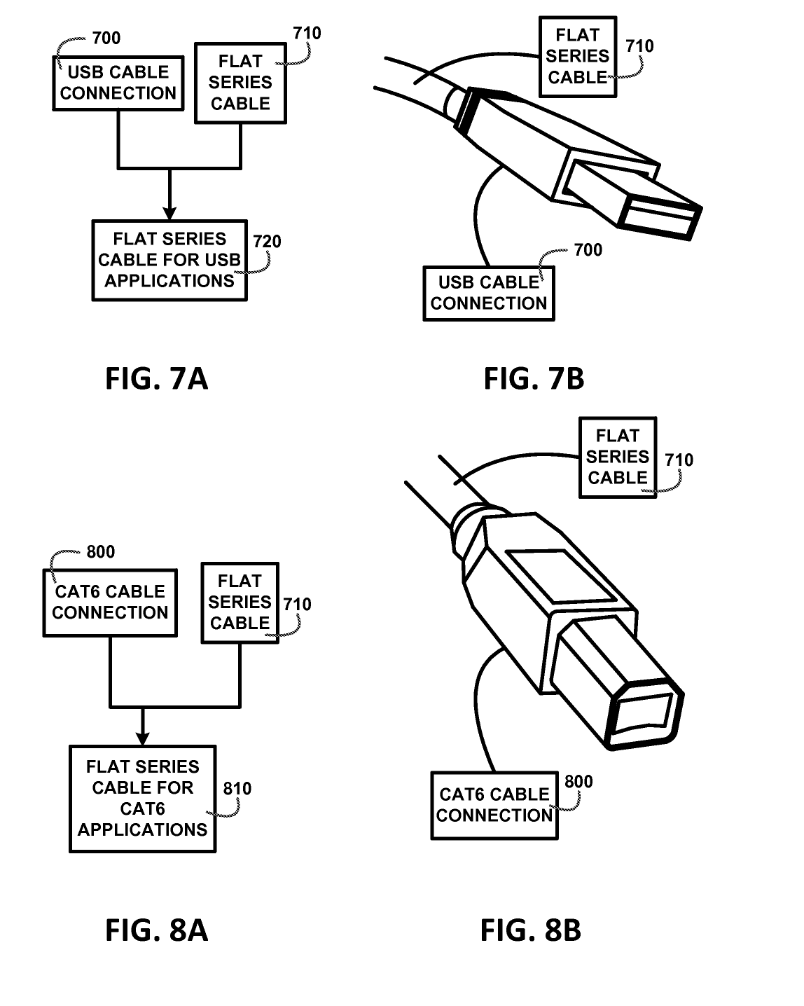

FIG. 7A shows a block diagram of an overview of a flat series cable for USB applications of one embodiment. FIG. 7A shows a USB cable connection 700 created using a flat series cable 710. A flat series cable for USB applications 720 allows USB applications where space is limited and the flat series cable 710 is used to make use of that limited access space of one embodiment.

### Flat Series USB Cable:

FIG. 7B shows for illustrative purposes only an example of a flat series USB cable of one embodiment. FIG. 7B shows the flat series cable 710 used in the fabrication of a USB cable connection 700. The flat series cable 710 USB cable connection is used in connecting digital devices to other devices for purposes including data transferring, communication of digital signals including music and images, recharging device and other uses and devices configured to use a USB cable connection of one embodiment.

### Flat Series Cable for CAT6 Applications:

FIG. 8A shows a block diagram of an overview of a flat series cable for CAT6 applications of one embodiment. FIG. 8A shows a CAT6 cable connection 800 fabricated using the flat series cable 710. The flat series cable for CAT6 applications 810 allows installations where limited physical access is available to connect devices configured for CAT6 cable connection 800 uses of one embodiment.

Flat Series CAT6 Cable:

FIG. 8B shows for illustrative purposes only an example of a flat series CAT6 cable of one embodiment. FIG. 8B shows the flat series cable 710 is configured to include a CAT6 cable connection 800 at one or both terminal ends of the flat series cable 710 of one embodiment.

The foregoing has described the principles, embodiments and modes of operation. However, the invention should not be construed as being limited to the particular embodiments discussed. The above described embodiments should be regarded as illustrative rather than restrictive, and it should be appreciated that variations may be made in those embodiments by workers skilled in the art without departing from the scope as defined by the following claims.

What is claimed is:

1. A method, comprising:
fabricating custom cables using a custom cable technology,
wherein the custom cables include a universal flat cable including a plurality of flexible conduits including a plurality of cable pods, an ultra-flat cable and a flat series cable, and
wherein the custom cables include reinforced cable jackets, and
wherein the custom cables include reduced weight cable jackets including a microcell jacket.

2. The method of claim 1, wherein fabricating custom cables using a custom cable technology includes a microcell jacket manufacturing process wherein pressurized silicone is processed through a mixing structure wherein a gas including air and carbon dioxide is infused into the pressurized silicone forming micro-bubbles throughout the silicone.

3. The method of claim 1, wherein fabricating custom cables including reinforced cable jackets includes a process wherein a cable jackets is configured to include reinforcing mesh encasing jacket tubing to increase crush resistance of cables with tubing and to protect against tube damage in over pressure conditions.

4. The method of claim 1, wherein the universal flat cable includes at least one cable pod, wherein the cable pod is a grouping of cables from a plurality of multiple flexible conduits that are attached to other groupings of cables forming the universal flat cable and wherein at least one cable pod can be split away and branched off from the universal flat cable.

5. The method of claim 1, wherein the ultra-flat cable include ultra-flat elements including an ultra-thin trace material configured for signal conductors and wherein the ultra-thin trace material includes a wire thicknesses in a range of 1 to 50 mils thickness.

6. The method of claim 1, wherein the ultra-flat cable include ultra-flat elements including an ultra-thin flat magnet type wire configured for power conductors including flat wire AWG's in a range of 15 to 30 AWG.

7. The method of claim 1, wherein the ultra-flat cable includes shielded ultra-flat cables.

8. The method of claim 1, wherein the flat series cable includes a flat series cable for USB applications configured to include at least one USB cable connection

9. The method of claim 1, wherein the flat series cable includes a flat series cable CAT6 cable configured to include at least one CAT6 cable connection.

10. The method of claim 1, further comprising custom cables include a psi-guard tubing wherein a clear mesh encases the tubing including a Teflon tubing and include a toughline flat cable wherein the cable includes a higher durometer silicone.

11. An apparatus, comprising:
a custom cable technology to fabricate custom cables;
a microcell jacket manufacturing process to fabricate a custom cable with micro-cell bubbles;
at least one custom cable including
a universal flat cable including a plurality of cable pods, an ultra-flat cable, a flat series cable, a reinforced cable jackets, a psi-guard tubing, a toughline flat cable, and wherein at least one custom cable includes a microcell jacket.

12. The apparatus of claim 11, further comprising a microcell jacket manufacturing process configured to include pressurized silicone processed through a mixing structure wherein a gas including air and carbon dioxide is infused into the pressurized silicone forming micro-bubbles throughout the silicone.

13. The apparatus of claim 11, further comprising the flat series cable configured to include at least one USB cable connection and configured to include at least one CAT6 cable connection.

14. The apparatus of claim 11, further comprising the psi-guard tubing is configured to include a clear mesh encasing at least one tubing including a Teflon tubing and the toughline flat cable is configured to include a higher durometer silicone.

15. The apparatus of claim 11, wherein the ultra-flat cable is configured to include ultra-flat elements including an ultra-thin trace material configured for signal conductors and wherein the ultra-thin trace material is configured to include a wire thicknesses in a range of 1 to 50 mils thickness and configured to include an ultra-thin flat magnet type wire configured for power conductors including flat wire AWG's in a range of 15 to 30 AWG.

16. An apparatus, comprising:
at least one custom cable;
at least one custom cable element; and
at least one custom cable technology process.

17. The apparatus of claim 16, further comprising at least one custom cable configured to include a universal flat cable including a plurality of cable pods, an ultra-flat cable, a flat series cable, a reinforced cable jackets, a psi-guard tubing, a toughline flat cable.

18. The apparatus of claim 16, further comprising at least one custom cable element configured to include a microcell jacket, ultra-flat elements, silicone, high durometer silicone, tubing, ultra-thin trace material, ultra-thin flat magnet type wire, mesh encasement and cable shielding.

19. The apparatus of claim 16, further comprising at least one custom cable technology process configured to include a microcell jacket manufacturing process.

20. The apparatus of claim 16, further comprising at least one custom cable configured to include at least one USB cable connection and at least one CAT6 cable connection.
